(19) United States
(12) Patent Application Publication
(10) Pub. No.: US 2012/0251311 A1
(43) Pub. Date: Oct. 4, 2012

(54) FUEL PUMP

(76) Inventors: Matthias Fischer, Datterode (DE); Bernd Jaeger, Fritzler (DE); Christoph Schmidt, Rotenburg (DE)

(21) Appl. No.: 13/516,645

(22) PCT Filed: Dec. 9, 2010
(86) PCT No.: PCT/EP2010/069252

§ 371 Date: Jun. 15, 2012

(30) Foreign Application Priority Data
Dec. 16, 2009 (DE) 102009058670.9
Jan. 25, 2010 (DE) 102010005642.1

(51) Int. Cl. F03B 11/02

(52) U.S. Cl. 415/208.1

(57) ABSTRACT

A fuel pump, including at least one driven impeller made of plastic, which rotates in a pump housing and on the sides having guide blades that each delimit at least one ring of blade chambers, and further having partial ring-shaped channels arranged on both sides in the region of the guide blades in the pump housing, said channels forming delivery chambers with the blade chambers for delivering fuel. An inlet channel leads into the one delivery chamber and the other delivery chamber leads into an outlet channel and the impeller contains carbon fibers embedded in the plastic.

### CROSS REFERENCE TO RELATED APPLICATIONS

This is a U.S. national stage of application No. PCT/EP2010/069252, filed on 9 Dec. 2010. Priority is claimed on German, Application No.: 10 2009 058 670.9, filed 16 Dec. 2009; and German Application No.: 10 2010 005 642.1, filed 25 Jan. 2010, the contents of which are incorporated here by reference.

### BACKGROUND OF THE INVENTION

1. Field of the Invention

The subject of the invention is a fuel pump comprising at least one driven impeller, made of plastic, which rotates in a pump housing and in its sides has guide blades which respectively delimit at least one ring of blade chambers, and further comprising partial ring-shaped channels arranged on both sides in the region of the guide blades in the pump housing, which channels form with the blade chambers delivery chambers for the delivery of fuel, wherein an inlet channel leads into one delivery chamber and the other delivery chamber leads into an outlet channel.

2. Description of Prior Art

Fuel pumps are used to deliver fuel from a fuel tank to an internal combustion engine of a motor vehicle and are thus known. Upon rotation of the impeller, the fuel is drawn up via the inlet channel, brought to a higher pressure level and delivered via the outlet channel, and the electric motor of the fuel pump, to a feed line which leads the fuel to the internal combustion engine. The pump housing is formed by a pump bottom and a pump cover. It is also known to additionally arrange a spacer between a pump bottom and a pump cover. For a rotation of the impeller in the pump housing, the impeller must be arranged at a distance from the pump housing parts. This means that a gap is respectively formed between the side of the impeller and the opposite part of the pump housing. It is attempted to keep this gap as small as possible, since these gaps form leakage points which reduce the efficiency of the fuel pump. On the other hand, the gaps must not be made too small in order to ensure that the impeller, upon rotation, does not come into contact with the housing parts, which would likewise reduce the efficiency of the fuel pump. In particular, the swelling behavior and tilts of the impeller can lead to contacts of the impeller with housing parts. To this end, it is known to coat, housing parts which make contact with the impeller in order additionally to protect these components.

In order to reduce the swelling tendency and increase the strength, it is further known to add glass fibers and mineral fillers to the impellers. Following the production of the impellers, usually by injection molding, these are additionally ground or lapped in order to obtain narrowest possible gap widths in relation to the housing parts. A drawback with this is that, through the subsequent machining of the grinding or lapping, the outer plastics coating produced in the injection molding is partially eroded, but not the added glass fibers which are present in this region. The consequence of this is that these glass fibers protrude with their ends partially out of the lapped surface and, upon rotation of the impeller, make contact with the opposite housing parts. Due to their strength and dimensional stability, these glass fibers produce a material erosion on the opposite housing parts or lead to a partial destruction of protective coatings disposed on the housing parts.

### SUMMARY OF THE INVENTION

An object of one embodiment of the invention is to provide a fuel pump comprising a high-strength, plastics impeller, which, even in the case of narrow gap widths, causes no damage to opposite housing parts or to protective coatings disposed thereon.

According to one embodiment of the invention, a fuel pump includes and that impeller contains carbon fibers embedded in the plastic.

With the admixture of carbon fibers, a strength which is approximately as good as with glass fibers is attained, without any harm to opposite housing components.

### BRIEF DESCRIPTION OF THE DRAWINGS

FIG. 1 is a fuel pump.

### DETAILED DESCRIPTION OF THE PREFERRED EMBODIMENTS

Strength is attained in the fuel pump, since the carbon fibers exhibit good tensile strength when embedded in the plastics matrix. At the same time, through the use of the carbon fibers, damage to opposite housing parts or to protective coatings disposed thereon is avoided, since the carbon fibers have a greater tendency to break in the course of the grinding or lapping, so that, through this alone, fewer fibers can make contact with opposite components. Ends of the carbon fibers which protrude freely from the side faces of the impeller are uncritical, since carbon fibers are flexible and hence bend upon contact with other components. They therefore do not have sufficient resistance, which could lead to damage of adjacent components. Due to their material properties, the freely protruding carbon fibers additionally act as a type of lubricant, so that impellers according to the invention have good emergency running characteristics.

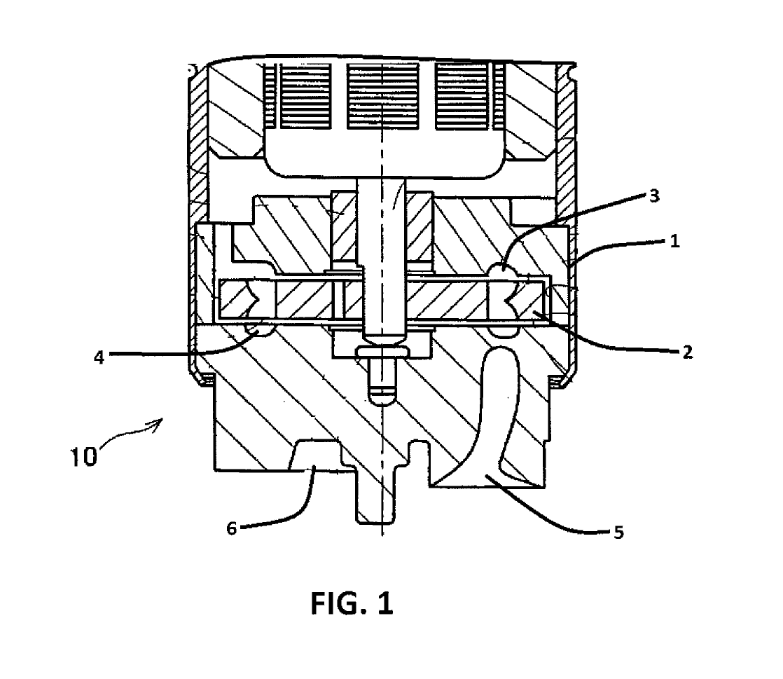

As shown in FIG. 1, a portion of the fuel pump 10 comprises a pump housing 1. At least one plastic driven impeller 2, having carbon fibers embedded in the plastic, rotates in the pump housing 1. The impeller 2 has guide blades that respectively delimit at least one ring of blade chambers. Partial ring-shaped channels 3, 4 are arranged on both sides in the pump housing 1 in the region of the guide blades that form delivery chambers for the delivery of fuel with the blade chambers. An inlet channel 5 leads into one delivery chamber and an outlet channel 6 leads into the other delivery chamber.

In an advantageous embodiment, the plastic is a polyphenylene sulfide or a phenolic resin-based plastic.

According to a further advantageous embodiment, the proportion of added carbon fibers is between 15 and 50 percent by weight, according to the intended magnitude of the desired mechanical strength. This is determined, inter alia, by the installation conditions and the operating parameters of the fuel pump. Particularly good results are obtained with admixtures ranging from 20 to 40 percent by weight, in particular of 30 percent by weight.

The length of the carbon fibers can likewise be varied within broad ranges. The ranges can extend from 0.1 mm to 1 mm. It has been shown, however, that carbon fibers having a length of about 1 mm are particularly suitable.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A fuel pump comprising:
a pump housing;
at least one plastic driven impeller, having carbon fibers embedded in the plastic, that rotates in the pump housing having guide blades that respectively delimit at least one ring of blade chambers;
partial ring-shaped channels arranged on both sides in the pump housing in the region of the guide blades that form delivery chambers for the delivery of fuel with the blade chambers;
an inlet channel that leads into one delivery chamber; and
an outlet channel that leads into the other delivery chamber.

8. The fuel pump as claimed in claim 7, wherein the plastic is one of a polyphenylene sulfide and a phenolic resin-based plastic.

9. The fuel pump as claimed in claim 7, wherein a proportion of carbon fibers is 15 to 50 percent by weight.

10. The fuel pump as claimed in claim 9, wherein the carbon fibers are about 1 mm in length.

11. The fuel pump as claimed in claim 9, wherein the carbon fibers are between 0.1 mm to 1 mm in length.

12. The fuel pump as claimed in claim 7, wherein the impeller further comprises graphite.

13. The fuel pump as claimed in claim 9, wherein the proportion of carbon fibers is 20 to 40 percent by weight.

14. The fuel pump as claimed in claim 13, wherein the proportion of carbon fibers is 30 percent by weight.

15. The fuel pump as claimed in claim 8, wherein the proportion of carbon fibers is one of 15 to 50 percent by weight, 20 to 40 percent by weight, and 30 percent by weight.
